(19) United States
(12) Patent Application Publication
(10) Pub. No.: US 2019/0333028 A1
(43) Pub. Date: Oct. 31, 2019

(54) NEXT GENERATION REWARD-GRANTING GLASS COLLECTION AND RECYCLING METHOD

(71) Applicant: PARK CAM SANAYI VE TICARET ANONIM SIRKETI, Bozuyuk (TR)

(72) Inventors: Selcuk KUCUKSEYHAN, JR., Bozuyuk (TR); Eyup Ayhan BALIN, Bozuyuk (TR)

(21) Appl. No.: 15/997,554

(22) Filed: Jun. 4, 2018

(30) Foreign Application Priority Data
Apr. 26, 2018 (TR) 2018/05909

(51) Int. Cl. G06Q 10/00; G06Q 30/02; G05B 15/02; G06K 7/14; G06K 19/06; B07C 5/342

(52) U.S. Cl. CPC G06Q 10/30; G06Q 30/0208; G05B 15/02; B07C 2501/0072; G06K 19/06037; B07C 5/342; G06K 7/1417

(57) ABSTRACT

The colored and transparent glass are separated and recycled by collecting them separately from the other packing wastes without exception of any brand and company. The glass is reintroduced to the economy, and a waste glass collection/recycling process motivates users by supplying advantages and particular rewards. The solution reduces total costs of recycling by offering a working method eliminating a “Transfer to CSF (Collection-Separation Facility) and separation” step after glass collection.

### CROSS-REFERENCE TO RELATED APPLICATIONS

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

Present invention defines the separation of colored and transparent glasses and recycling them by collecting them separately from the other packing wastes without exception of any brand and company, reintroducing them to the economy, and a waste glass collection/recycling process aiming to motive users by supplying advantages and particular rewards.

Present invention provides a solution reducing total costs of recycling by offering a working method eliminating “Transfer to CSF (Collection-Separation Facility) and separation” step after glass collection mentioned in the project described in the patent document “YENİ NESİL ÖDÜLLÜ CAM TOPLAMA ve GERİ KAZANMA YÖNTEMİ” (NEXT GENERATION REWARD-GRANTING GLASS COLLECTION AND RECYCLING METHOD) dated 22 Dec. 2017 and filed with the number P 2017/21196 which leads the present invention.

### 2. Description of Related Art Including Information Disclosed Under 37 CFR 1.97 and 37 CFR 1.98.

The application being one of the projects of the state of the art, included in Turkish Patent and Trademark Office records, and carried out in the similar field to the present invention is presented below:

| No | Application No | Invention Title |
|---|---|---|
| 1 | 2017/21196 | NEXT GENERATION REWARD-GRANTING |
| | | GLASS COLLECTION and RECYCLING |
| | | METHOD |

Glass collection and recovery method of this table and still offered by the present inventor bases on constituting and operating a collection-separation facility in order to separate glass wastes from the other wastes in the special-designed glass waste containers named as “cambank” (glassbank) during the process.

Projects registered by Turkish Patent and Trademark Office and international patent offices, as well as the invention titled “YENİ NESİL ÖDÜLLÜ CAM TOPLAMA ve GERİ KAZANMA YÖNTEMİ” dated 22 Dec. 2017 and filed with the number P 2017/21196, and the methods applied in the market and used in glass collection/transfer to CSF (Collection-Separation Facility) were examined; and it was concluded that there is no system exactly offering solution to the technical problems mentioned in the following chapter, in the investigation carried out before the application.

### BRIEF SUMMARY OF THE INVENTION

### Technical Problems the Invention Aims to Solve

Glass collection/separation/containers used in breaking and their transfer to CSF (Collection-Separation Facility) processes which have been used in the market, as well as the—prior art—projects registered by Turkish Patent and Trademark Office and international patent offices provide the solution targeted for reintroducing glass wastes to the economy by means of recycling to a certain degree.

In many projects, recyclable materials such as paper/plastic/glass, etc. are stored in one container in a mixed manner. In the applications in which waste glasses are stored separately, they are not separated according to their colors, each glass waste having different colors are collected in the same container without any processing and by preserving the present form. The invention titled Diş Mekânlar için Cam Kirici/Toplayici Konteyner-IV ″ Application No. 2017/12040 being registered by Turkish Patent and Trademark Office provides solution to this problem to a certain extend by separating transparent and colored bottles into entirely isolated two channels as Transparent bottle access and Colored bottle access in order to process them without mixing.

Such applications necessitate expensive/time-consuming “separation” processes which require energy consumption in Recycling Facilities. Though their contributions to protecting the environment are indisputable, recycling processes have to be economical in order to be sustainable.

The main problem in the application is that packaging glass and glass wastes may not be collected and utilized efficiently. In other words:

Only 150.000 tons corresponding to 10% of annual 1.5 million tons of packaging glass manufacture may be collected as glass wastes. When the reasons of this are investigated, it is understood that:
While economic value of waste glass and packaging glass is (about) 100-200 TL/tons, the economic value of waste paper/cardboard/paperboard and etc. is (about) 500-600 TL/tons, and
Glass wastes are not preferred in collection/storage and transportation stages because of their disadvantages such as weight and sharpness.

Consequently, the invention P 2017/21196 of 22 Dec. 2017 titled “YENİ NESİL ÖDÜLLÜ CAM TOPLAMA ve GERİ KAZANMA YÖNTEMİ” which constitutes a basis for the present invention provides a significant solution to the problems described above, however it inevitably includes the work step of transfer to CSF (Collection-Separation Facility) and the separation which is an obligatory process to be done here.

### BRIEF DESCRIPTION OF THE SEVERAL VIEWS OF THE DRAWINGS

Reward-granting “Packaging Glass Collection System” (PGCS) designed to offer the solution to the problems mentioned above is illustratively described by the attached figures.

FIG. 1 is a schematic view of details of the cambank.

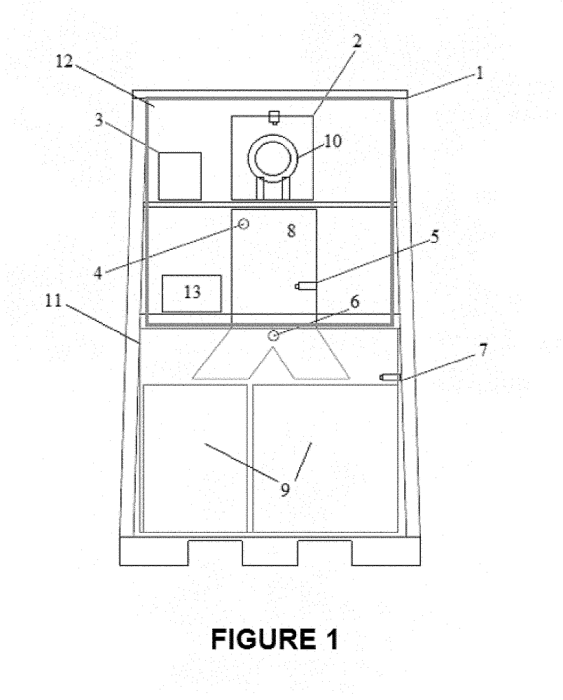

FIG. 2 is a schematic illustration of a reward system as a workflow diagram for subscription/collection in Cambank.

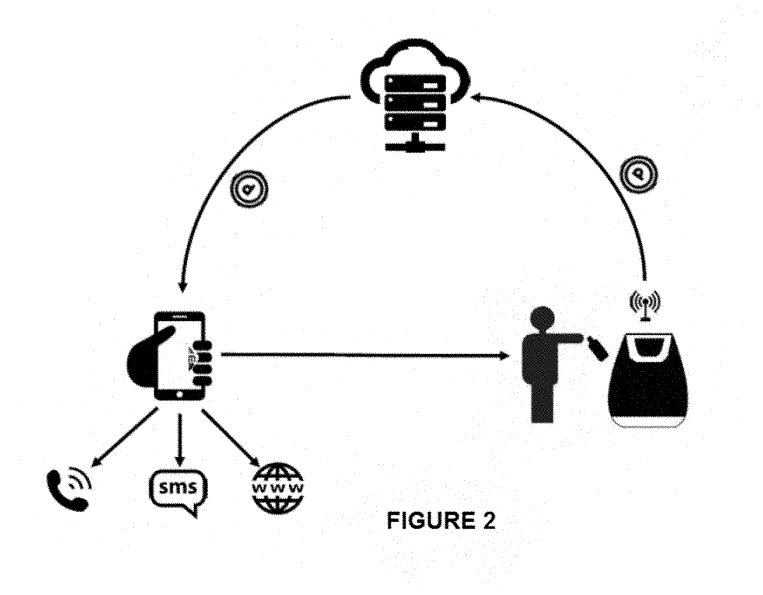

FIG. 3 is a schematic illustration of a reward system as a workflow diagram for recycling process.

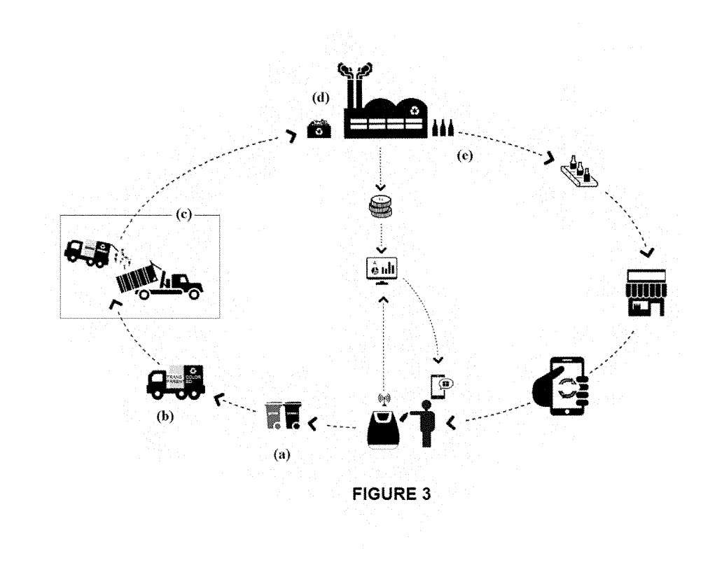

### REFERENCES IN THE DRAWINGS

Members in the figures are numbered and their equivalences are shown below:

1) Outer case

2) Conveyor

3) Recognition system

4) Unidentified waste flap motor

5) Waste counter

6) Color separation flap motor

7) Level sensor

8) Breaker

9) Broken waste chamber

10) Neck plastic

11) Front service lid

12) Rear service lid

13) Point system software

### DETAILED DESCRIPTION OF THE INVENTION

Next-generation glass collection and recycling method of the invention comprises a container which was designed for this method especially.

The container is referred to as “Cambank” in the following parts of this description.

Although Cambank has structural similarities to the container described in the predecessor invention P 2017/21196 of 22 Dec. 2017 titled “YENİ NESİL ÖDÜLLÜ CAM TOPLAMA ve GERİ KAZANMA YÖNTEMİ” (of the same inventor), the subscriber recognition system of present invention is redesigned such that only users subscribing to Reward-Granting “Packaging Glass Collection System” (PGCS) are able to open the waste chamber after introducing themselves into the system. By means of additional safety control feature of Cambanks, warning/discarding subscribers who carries out irregular application is enabled when materials except for glass (plastic, PET or other non-recyclable wastes) are thrown into the container.

Broken glass pieces which are stored by automatically sorting as transparent and colored glass wastes in Cambanks are thrown into intermediary collection containers as transparent and colored glasses and transferred to the trucks and vans allowing transparent and colored glass pieces to be loaded separately to the trailers.

Waste materials taken from Cambanks are subjected to the basic separation process in three dimensional machines in Recycling Facilities and allowed to be directed to glass manufacturing furnace batch area with the quality of Ready-to-Furnace Glass Pieces (RFGP).

Cambank is designed to have the following equipment properties so as to support reward-granting glass collection and recycling method:
In the front face, a touch data input display into which the users manually dial user name and password while introducing themselves into the reward system,
Alternatively, a QR reader enabling QR Code screened on the display of the user's mobile phone to be read,
IP data communication system enabling the “Fullness Alarm” produced by the system to be triggered and transferred through the GSM network to “Control and Management Center” in Mobile data format, on the condition that value obtained from the weight sensor reaches 850 bottles being 85% of the total capacitiy of 1000 bottles,
Electromechanical control system detecting whether the material thrown into Cambank is a non-glass material,
A control mechanism recording the subscribers throwing the material detected to be non-glass, warning them and/or deactivating their subscription,
A system enabling the material detected to be non-glass to be transferred from Cambank,
A counter determining the numbers of the bottles subject to the reward which are thrown by the user.

Outer case (1) of Cambank is made of composite material resistant to huge impacts and fires. There is a high-resolution Recognition system (3) on the front face ensuring the recognition of registered user of Cambank. A neck plastic (10) is provided in order to prevent glass wastes to be subject to impacts on the conveyor (2) inlet. Other wastes which are not detected to be colored or transparent glass are thrown out of the container upon activating Unidentified waste flap motor (4) and the control mechanism enabling the subscriber who has thrown the material detected to be non-glass to be recorded, warned and/or removed from subscription is activated by the Point system software (13). A waste counter (5) located in the breaker (8) counts the number of bottles thrown to Cambank by the subscribed user and transfers this data to Point system software (13). Waste bottles are subjected to the separation process activated by Color separation flap motor (6) before they are directed to Broken waste chamber (9) and transparent and colored glass pieces are transferred to separate chambers.

The system is equipped with Front and Rear service lids (11, 12) in order to provide easy access to Broken waste chamber (9) and mechanic/electronic elements located in the upper section for maintenance/repair or dumping. On the condition that Broken waste chamber (9) is entirely full, Level sensor (7) gives the alarm and shuts the Conveyor (2). The user is informed via a message screened on the display of the Recognition system (3).

These technical properties of Cambank enables reward-granting glass collection and recycling method described in detail below to be applied:
Any person who desire to subscribe in “Packaging Glass Collection System” (PGCS) firstly visits www.bircambankasi.com website and then easily realizes this subscription by a username and a password determined by themselves, and the user's name, surname, birth date and mobile phone number information are acquired during the subscription,
Subscription is activated upon the entrance of verification password sent to the new subscriber's cell phone via SMS,
Cambank automat displays a QR code on the screen after the transaction,
The subscriber scans this QR code, opens the waste chamber and starts gaining points by throwing glass bottles to cambank automat,
Control mechanism is activated for determining the material except for colored or transparent glass bottles,
When such wastes are determined, one of the transactions of warning and/or blocking the subscriber is activated,
Cambank automats recognizes and stores broken colored and transparent glass bottles and also recognizes wastes other than glass bottles and sends them to the mixed waste chamber out of the automat,
The transaction started with scanning QR code by the subscriber is concluded by registering the point corresponding to the glass bottle number accepted by Cambank automat in the subscriber's account,
Subscribers may purchase minute and data packages in return for their points obtained and deposit these products to other mobile phone numbers.

If desired, users may download Mobile application of PGCS to their mobile devices. Mobile application may provide the user with the location information of the nearest Cambank by evaluating map and location information by means of an interactive communication with Control and Management Center, create a route for going to the desired Cambank location, keep the saved reward points accumulated in the user's account, and store user's information in the form of a QR code image and make user's access to Cambank practical.

The most significant innovation provided by the system is that Cambank is designed such that it will never allow wastes except for glass bottles to be directed to the waste chamber. By this approach, transfer to CSF (Collection-Separation Facility) and separation stage carried out here which have necessarily been in the work flow of the invention P 2017/21196 of 22 Dec. 2017 titled “YENİ NESİL ÖDÜLLÜ CAM TOPLAMA ve GERİ KAZANMA YÖNTEMİ is removed from the operational cycle and thus a significant economic advantage is obtained. Previous project targeted increasing the quality of RFGP (Ready-to-Furnace Glass Pieces) and succeeded this; however transfer to CSF (Collection-Separation Facility) and separation stage carried out here consist the weakness of this project.

By the novelties of the invention, transfer to CSF (Collection-Separation Facility) and separation stage carried out here is eliminated and the wastes stored in Cambank are enabled to have the property directly close to the quality of RFGP (Ready-to-Furnace Glass Pieces).

Industrial applicability way of the invention

In the invention of this patent application, consumers are motivated for utilizing packaging glass wastes by means of PGCS subscription system. It is estimated that the recycling rate of 10% will increase up to about 60-70% by means of applying the system.

Wastes stored in Cambank are enabled to have the property directly close to the quality of RFGP (Ready-to-Furnace Glass Pieces), “separation” processes being expensive/requiring extra energy consumption, inefficient, and having high labor cost are totally eliminated, and time and cost savings are accomplished. By reducing the process costs of recycling, it is aimed that investments to be carried out in this area will become more attractive and environmental protection will be contributed. Because the quality of RFGP is increased within this system, production quality of packaging glass is increased likewise and because it reduces business costs, the system may be enabled to be sustainable. Another advantageous aspect of the system is that it has a control mechanism identifying and blocking malicious persons aiming to obtain point by throwing non-glass wastes to the Cambank automats and/or removing them from the system.

1. A cambank used in a glass collection method, comprising: a means for registration, means for warning and/or unsubscribing of the subscriber throwing the material detected to be non-glass a means for ensuring the transfer of such material from Cambank.

2. A method for granting rewards for glass collection in a cambank, the method comprising the following steps:
entering a subscription of the users by providing name, surname, date of birth and mobile phone number information through the Subscription application working in the platforms such as PC, Laptop, and smart phones,
carrying out said subscription upon entering the verification password sent to the new subscriber's mobile phone through SMS,
displaying a QR code on the screen by Cambank automat at the end of the transaction,
opening a waste chamber by scanning this QR code by the subscriber and to start gaining points by throwing glass bottle wastes to Cambank automat,
activating a control mechanism in order to determine the material except for colored or transparent glass bottle,
warning and/or blocking subscribers when such wastes are detected,
identifying and storing colored and transparent glass bottles in separate chambers, and to identify and send other wastes other than glass bottles into the mixed waste chamber out of the automat, and
finalizing a transaction started by the subscriber by means of scanning the QR code, upon entering the point corresponding to the glass bottle number accepted by Cambank automat into the user's account.

3. A method for granting rewards for glass collection, the method comprising the following steps:
a) storing glass pieces transferred to Cambank in Intermediary collection containers in a separate manner according to their colors,
b) transporting colored and transparent glass pieces to the transfer points by vans whose trailers allow for loading them separately,
c) transferring transparent and colored glass pieces by higher-capacity dump trucks without mixing them,
d) directly sending separated wastes having the property close to the quality of RFGP (Ready-to-Furnace Glass Pieces) to the recycling facility,
e) leading to the glass manufacturing furnace batch area in the quality of RFGP (Ready-to-Furnace Glass Pieces) by subjecting them to the basic separation process by the three dimensional machines in the Recycling Facilities, and
f) manufacturing as glass bottles again here.
